(19) United States
(12) Patent Application Publication
(10) Pub. No.: US 2009/0048835 A1
(43) Pub. Date: Feb. 19, 2009

(54) FEATURE EXTRACTING APPARATUS, COMPUTER PROGRAM PRODUCT, AND FEATURE EXTRACTION METHOD

(75) Inventor: Takashi Masuko, Tokyo (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/042,018

(22) Filed: Mar. 4, 2008

(30) Foreign Application Priority Data
Aug. 17, 2007 (JP) 2007-212739

(51) Int. Cl. G10L 15/00

(52) U.S. Cl. 704/236; 704/E15.001

(57) ABSTRACT

A feature extracting apparatus includes a spectrum calculator that calculates a logarithmic frequency spectrum including frequency components obtained from an input speech signal at regular intervals on a logarithmic frequency scale of a frame; a function calculator that calculates a cross-correlation function between a logarithmic frequency spectrum of a time and a logarithmic frequency spectrum of one or plural times included in a certain temporal width before and after the time, from a sequence of the logarithmic frequency spectra calculated at each time; and a feature extractor that extracts a set of the cross-correlation functions as a local and relative fundamental-frequency pattern feature at the frame.

### CROSS-REFERENCE TO RELATED APPLICATIONS

This application is based upon and claims the benefit of priority from the prior Japanese Patent Application No. 2007-212739, filed on Aug. 17, 2007; the entire contents of which are incorporated herein by reference.

### BACKGROUND OF THE INVENTION

1. Field of the Invention

The present invention relates to a feature extracting apparatus, a computer program product, and a feature extraction method.

2. Description of the Related Art

One of elements constituting prosodic information of a speech is fundamental frequency pattern information. The fundamental frequency pattern information is for obtaining information about an accent, an intonation, or a voiced or unvoiced sound. The fundamental frequency pattern information is utilized in speech recognition apparatuses, voice-activity detecting apparatuses, pitch extracting apparatuses, speaker recognition apparatuses, and the like. To obtain the fundamental frequency pattern information, pitch extraction needs to be performed using a technique as described in “Digital speech processing (in Japanese), by Sadaoki Furui, Tokai University Press, pp. 57 to 59, (1985)”, or the like.

Japanese Patent No. 2940835 proposes a method that regards a cross-correlation function between an auto-correlation function of a prediction residual of a speech at a certain time (frame) t and an auto-correlation function of a prediction residual of the speech at another time (frame) s as a pitch-frequency difference feature. According to this method, influences of a pitch extraction error are reduced, thereby obtaining pitch-frequency difference information in view of plural pitch frequency candidates.

However, because the method proposed by Japanese Patent No. 2940835 relies on the prediction residual of a speech, the feature is easily deteriorated by influences of background noises. The auto-correlation function of the prediction residual has plural peaks appearing at positions corresponding to integral multiples of the pitch period. When the peaks at the positions of the integral multiples of the pitch period are employed, differential values become integral multiples. Therefore, to obtain correct pitch frequency difference information, a range of the auto-correlation function of the prediction residual for obtaining the cross-correlation function needs to be restricted to near a correct pitch period. To that end, the pitch period needs to be previously obtained, or a range of the pitch period needs to be properly defined according to the height of voice of a speaker.

### SUMMARY OF THE INVENTION

According to one aspect of the present invention, a feature extracting apparatus includes a spectrum calculator that calculates a logarithmic frequency spectrum including frequency components obtained from an input speech signal at regular intervals on a logarithmic frequency scale of a frame; a function calculator that calculates a cross-correlation function between a logarithmic frequency spectrum of a time and a logarithmic frequency spectrum of one or plural times included in a certain temporal width before and after the time, from a sequence of the logarithmic frequency spectra calculated at each time; and a feature extractor that extracts a set of the cross-correlation functions as a local and relative fundamental-frequency pattern feature at the frame.

According to another aspect of the present invention, a feature extracting method includes calculating a logarithmic frequency spectrum including frequency components obtained from an input speech signal at regular intervals on a logarithmic frequency scale of a frame; calculating a cross-correlation function between a logarithmic frequency spectrum of a time and a logarithmic frequency spectrum of one or plural times included in a certain temporal width before and after the time, from a sequence of the logarithmic frequency spectra calculated at each time; and extracting a set of the cross-correlation functions as a local and relative fundamental-frequency pattern feature at the frame.

A computer program product according to still another aspect of the present invention causes a computer to perform the method according to the present invention.

### BRIEF DESCRIPTION OF THE DRAWINGS

FIG. 1 is a block diagram of a hardware configuration of a speech recognition apparatus according to a first embodiment of the present invention;

FIG. 2 is a block diagram of a functional configuration of a feature extracting apparatus;

FIG. 3 is a graph of logarithmic frequency spectra of five frames included in a voiced segment of a clean speech;

FIG. 4 is a graph of cross-correlation functions of the logarithmic frequency spectra;

FIG. 5 is a graph of logarithmic frequency spectra obtained from speech including noises;

FIG. 6 is a graph of cross-correlation functions of the logarithmic frequency spectra of FIG. 5;

FIG. 7 is a block diagram of a functional configuration of a feature extracting apparatus according to a second embodiment of the present invention;

FIG. 8 is a block diagram of a functional configuration of a feature extracting apparatus according to a third embodiment of the present invention;

FIG. 9 is a graph partially showing cross-correlation functions of logarithmic frequency spectra;

FIG. 10 is a graph of results that are obtained by approximating the cross-correlation functions of FIG. 9;

FIG. 11 is a block diagram of a functional configuration of a feature extracting apparatus according to a fourth embodiment of the present invention; and

FIG. 12 is a graph of examples of cross-correlation functions in an unvoiced segment.

### DETAILED DESCRIPTION OF THE INVENTION

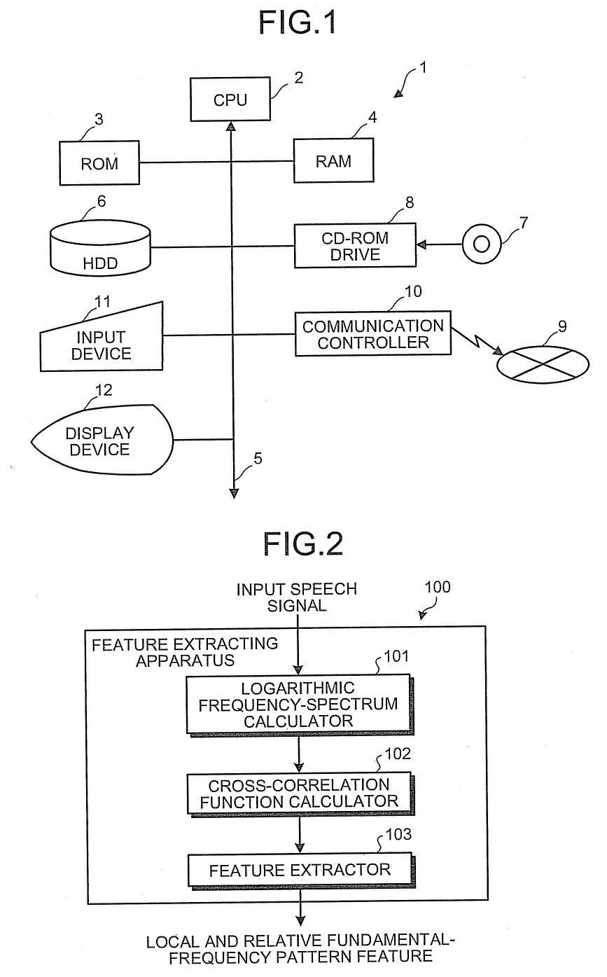

A first embodiment of the present invention is explained with reference to FIGS. 1 to 6. The first embodiment is an example of application to a feature extracting apparatus included in a speech recognition apparatus.

FIG. 1 is a block diagram of a hardware configuration of a speech recognition apparatus 1 according to the first embodiment. The speech recognition apparatus 1 according to the first embodiment generally performs a speech recognizing process of automatically recognizing human speeches by a computer.

As shown in FIG. 1, the speech recognition apparatus 1 is a personal computer, for example. The speech recognition apparatus 1 includes a central processing unit (CPU) 2 that is a principal part of the computer and centrally controls components of the computer. A read only memory (ROM) 3 that stores a basic input/output system (BIOS) and the like, and a random access memory (RAM) 4 that rewritably stores various data are connected to the CPU 2 through a bus 5.

To the bus 5, a hard disk drive (HDD) 6 that stores various programs, a CD (compact disc)-ROM drive 8 that reads a CD-ROM 7 as a mechanism for reading computer software as a distributed program, a communication controller 10 that controls communications between the speech recognition apparatus 1 and a network 9, an input device 11 that performs various operational instructions such as a keyboard and a mouse, and a display device 12 that displays various kinds of information such as a cathode ray tube (CRT) and a liquid crystal display (LCD) are connected through an input/output (I/O) (not shown).

Because the RAM 4 can rewritably store various data, the RAM 4 functions as a work area of the CPU 2 and acts as a buffer and the like.

The CD-ROM 7 shown in FIG. 1 implements a storage medium according to the present invention, and stores an operating system (OS) and various programs. The CPU 2 reads the program stored in the CD-ROM 7 by the CD-ROM drive 8, and installs the program in the HDD 6.

Various types of media, for example, various kinds of optical disks such as a digital versatile disk (DVD), various kinds of magnetic disks such as a magneto-optical disk and a flexible disk, and semiconductor memories can be employed as storage media, as well as the CD-ROM 7. A program can be downloaded from the network 9 such as the Internet via the communication controller 10, and installed in the HDD 6. In this case, a storage device that stores the program in a server on a transmitting end is a storage medium according to the present invention. The program can run on a predetermined OS. In such a case, part of various processes (which are explained later) can be taken over by the OS, or can be included as part of a group of program files that configure predetermined application software or the OS.

The CPU 2 that controls the operation of the entire system performs the various processes based on a program loaded on the HDD 6 that is used as a main memory of the system.

A characteristic function of the speech recognition apparatus 1 according to the first embodiment, among functions that are performed by the CPU 2 according to the various programs installed in the HDD 6 of the speech recognition apparatus 1 is explained.

FIG. 2 is a block diagram of a functional configuration of a feature extracting apparatus 100 included in the speech recognition apparatus 1. As shown in FIG. 2, the speech recognition apparatus 1 includes the feature extracting apparatus 100 that extracts a local and relative fundamental-frequency pattern feature, according to a program. The local and relative fundamental-frequency pattern feature is one of elements constituting the prosodic information of a speech, used for the speech recognizing process. This is fundamental frequency pattern information that enables to acquire information about the accent, the intonation, or a voiced/unvoiced sound.

As shown in FIG. 2, the feature extracting apparatus 100 according to the first embodiment includes a logarithmic frequency-spectrum calculator 101, a cross-correlation function calculator 102, and a feature extractor 103. The logarithmic frequency-spectrum calculator 101 serves as a spectrum calculating unit. The logarithmic frequency-spectrum calculator 101 calculates a logarithmic frequency spectrum including frequency components that are obtained from an input speech signal at regular intervals on a logarithmic frequency scale for each time (frame) with predetermined intervals. The cross-correlation function calculator 102 serves as a function calculating unit. The cross-correlation function calculator 102 calculates, from a sequence of the logarithmic frequency spectra calculated at each time by the logarithmic frequency-spectrum calculator 101, a cross-correlation function between a logarithmic frequency spectrum at each time and a logarithmic frequency spectrum at one or plural times included in a certain temporal width extending before and after the time. The feature extractor 103 serves as a feature extracting unit, and extracts a set of the cross-correlation functions calculated by the cross-correlation function calculator 102 as a local and relative fundamental-frequency pattern feature at a frame. The logarithmic frequency-spectrum calculator 101, the cross-correlation function calculator 102, and the feature extractor 103 are hereinafter explained in detailed.

The logarithmic frequency-spectrum calculator 101 is first explained. The logarithmic frequency-spectrum calculator 101 obtains from an input speech signal, a logarithmic frequency spectrum Sₜ(w) including frequency components that are obtained at frequency points equally spaced on a logarithmic frequency scale, per frame (for example, 10 milliseconds). Here, t denotes a frame number, and w (0=w<W) denotes a frequency point number. Specifically, the logarithmic frequency spectrum Sₜ(w) is obtained by frequency axis conversion of a linear frequency spectrum that is obtained according to Fourier transform, wavelet transform based on frequency points at regular intervals on the logarithmic frequency scale, or the Fourier transform based on frequency points at regular intervals on the logarithmic frequency scale, or the like.

A logarithmic frequency spectrum to which amplitude normalization has been performed can be alternatively used. The amplitude normalization is specifically performed by using a method of setting an average of the amplitudes of the logarithmic frequency spectrum at a constant value (for example, zero), a method of setting a variance at a constant value (for example, one), a method of setting the minimum and maximum values at constant values (for example, zero and one), a method of setting a variance of amplitudes of a speech waveform for which the logarithmic frequency spectrum is obtained at a constant value (for example, one), or the like.

A logarithmic frequency spectrum of residual components that are obtained by eliminating spectrum envelopes can be alternatively employed. The logarithmic frequency spectrum of residual components can be obtained from a residual signal obtained by a linear prediction analysis or the like, or by the Fourier transform of high-order components of cepstrum. The amplitude normalization can be performed for the logarithmic frequency spectrum of the residual components.

In calculating the logarithmic frequency spectrum, when the range for obtaining the frequency components is set at for example from 200 hertz to 1600 hertz in which speech energy is relatively large, the logarithmic frequency spectrum that is hardly affected by the background noises can be obtained.

The cross-correlation function calculator 102 is explained. The cross-correlation function calculator 102 calculates, for each frame t, a cross-correlation function Cₜ (τ, n) between the logarithmic frequency spectrum Sₜ(w) of the frame t and a logarithmic frequency spectrum S_{t+τ}(w) of a frame t+τ included in a certain temporal width (neighborhood N) before and after the frame t. Here, n denotes a magnitude of deviation (lag) on the logarithmic frequency scale, and its value is given by a group L of certain integers included from −(W−1) to (W−1). The cross-correlation function Cₜ(τ, n) is calculated by the following formula (1).

$${C}_{t} ( τ , n ) = \frac{1}{W - \vert n \vert} {\sum }_{i} {S}_{t} ( i ) {S}_{t + τ} ( i + n ) \\ where {S}_{t} ( w ) = 0 ( w < 0 , w \geq W ) \qquad ( 1 )$$

The term 1/(W−|n|) of the right-hand side of the formula (1) compensates reduction in the number of frequency components used for calculating the cross-correlation function, due to increase in the absolute value of the lag, and is not always necessary. When a relation of Cₜ(τ, n)=C_{t+τ}(−τ, −n) is utilized, the amount of calculation of the formula (1) can be reduced.

The feature extractor 103 extracts a set of the cross-correlation functions obtained as described above, i.e., Cₜ(τ, n) (τεN, nεL), as the local and relative fundamental-frequency pattern feature at the frame t.

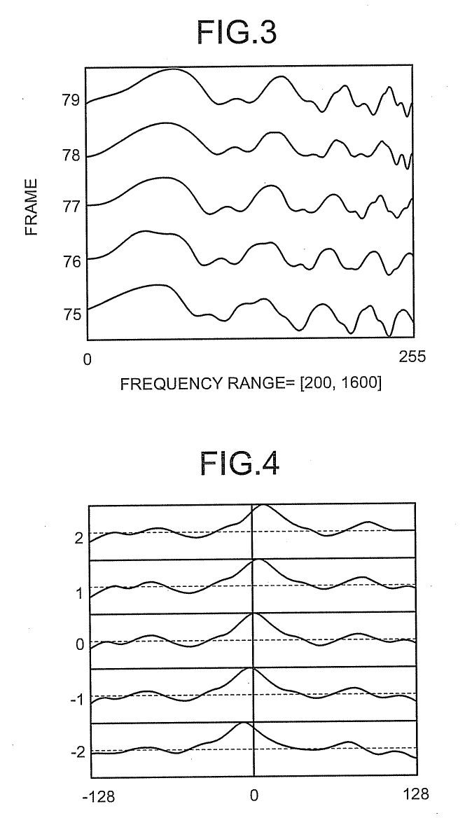

Examples of the logarithmic frequency spectrum and the cross-correlation function are shown in FIGS. 3 to 6.

FIG. 3 is a graph of the logarithmic frequency spectra of five frames included in a voiced segment of a clean speech. In FIG. 3, the horizontal axis denotes the frequency point number, and the vertical axis denotes the frame number. The logarithmic frequency spectrum in FIG. 3 includes frequency components of 256 points that are equally spaced on the logarithmic frequency scale, in a frequency band from 200 hertz to 1600 hertz. The amplitude is normalized to have the average of zero and the variance of one.

FIG. 4 is a graph of the cross-correlation functions of the logarithmic frequency spectra. FIG. 4 depicts the logarithmic frequency spectra obtained by setting a frame 77 in FIG. 3 as a reference frame. In FIG. 4, the horizontal axis denotes the lag, and the scale on the vertical axis denotes a difference in the frame number between the reference frame and a frame for which the cross-correlation function is obtained. For example, a difference −2 represents a cross-correlation function between the frame 77 and a frame 75. A difference 0 is equal to the auto-correlation function. The vertical axis of a box corresponding to each frame denotes a value from −1 to 1 of the cross-correlation function, and the horizontal dashed line in the center of the box represents 0 (zero).

That is, a set of the cross-correlation functions in FIG. 4 is a local and relative fundamental-frequency pattern feature of the frame 77 in the case of the neighborhood N={−2, −1, 0, 1, 2}.

Four or five peaks appear in the logarithmic frequency spectra shown in FIG. 3, each corresponding to a harmonic component at a position of an integral multiple of the fundamental frequency. The peaks of the logarithmic frequency spectra are shifted to the right as the frame number is increased. This corresponds to increases in the fundamental frequency. In FIG. 4, peaks near the lag 0 are shifted to the right as the frame number is increased. This corresponds to the shifting of the peaks of the logarithmic frequency spectra. That is, fluctuations of the peak near the lag 0 of the cross-correlation function correspond to fluctuations of the fundamental frequency.

The graph in FIG. 3 shows that the amounts of shifting in any of the peaks (harmonic components) of the logarithmic frequency spectra due to the fluctuations of the fundamental frequency are alike. Namely, any of the peaks (harmonic components) has the same amount of shifting.

According to the first embodiment, the local and relative fundamental-frequency pattern feature is obtained based on the cross-correlation function of the logarithmic frequency spectrum. Consequently, any of the peaks (harmonic components) of the logarithmic frequency spectrum due to fluctuations of the fundamental frequency has the same shifting amount, so that the fluctuations of the peak near the lag 0 of the cross-correlation function correspond to the fluctuations of the fundamental frequency. Accordingly, the fundamental frequency pattern information can be obtained without the need of the pitch extraction or the range specification of the pitch period. That is, there is no need of selecting a specific harmonic component to be used, and the local and relative fundamental-frequency pattern feature can be obtained without previously obtaining the fundamental frequency or specifying a range of the fundamental frequency of the speaker.

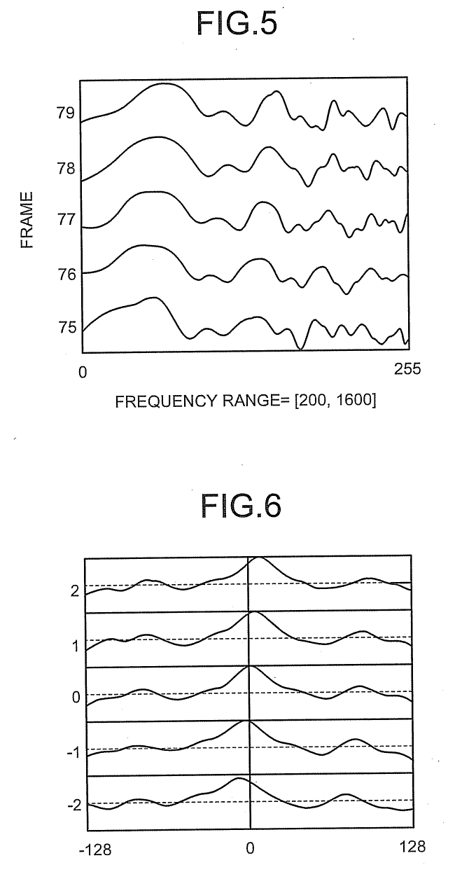

FIG. 5 depicts logarithmic frequency spectra obtained from a speech that is obtained by adding white noises at 10 decibels to the speech used in FIG. 3. FIG. 6 depicts cross-correlation functions obtained from the logarithmic frequency spectra of FIG. 5. Comparing FIGS. 3 and 5, it is found that similar logarithmic frequency spectra are obtained particularly in lower frequency bands. This is because speech energy is relatively large in a band near from 200 hertz to 1600 hertz. In FIG. 6, peaks near the lag 0 are changed in the same manner as in FIG. 4, which shows that a local and relative fundamental-frequency pattern feature similar to that of FIG. 4 is obtained.

As described above, the first embodiment enables to prevent the feature from being easily affected by the influences of the background noises. Therefore, a stable local and relative fundamental-frequency pattern feature can be obtained without being affected so much by noises.

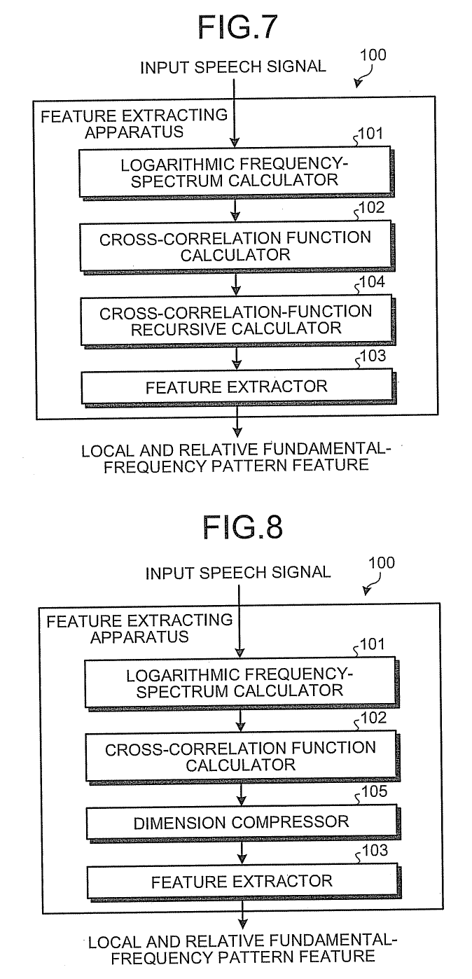

A second embodiment of the present invention is explained with reference to FIG. 7. The same or corresponding parts as those in the first embodiment are denoted by like reference numerals, and explanations thereof will be omitted.

FIG. 7 is a block diagram of a functional configuration of the feature extracting apparatus 100 according to the second embodiment. As shown in FIG. 7, the feature extracting apparatus 100 according to the second embodiment is different from that of the first embodiment in that it includes a cross-correlation-function recursive calculator 104 that recursively calculates a cross-correlation function at each time, from the cross-correlation function calculated at each time by the cross-correlation function calculator 102.

The cross-correlation-function recursive calculator 104 serves as a recursive calculating unit. The cross-correlation-function recursive calculator 104 assumes Cₜ⁽¹⁾(τ, n)=Cₜ(τ, n) and recursively calculates a cross-correlation function Cₜ⁽ⁱ⁾(τ, n) between a set of cross-correlation functions, Cₜ⁽ⁱ⁻¹⁾(τ, n) (τεN, nεL), of each frame t and a set of cross-correlation functions, C_{t+τ}⁽ⁱ⁻¹⁾(λ, n) (λεN, nεL), of a frame t+τ included in a certain temporal width (neighborhood N) before and after the frame t, according to the following formula (2).

$${C}_{t}^{( i )} ( τ , n ) = {\sum }_{u} {\sum }_{j} {C}_{t}^{( i - 1 )} ( u , j ) {C}_{t + τ}^{( i - 1 )} ( u - τ , j + n ) ( i \geq 2 ) \qquad ( 2 )$$

The term for compensating fluctuations according to the number of components used for calculation of the cross-correlation function, can be added to the right-hand side of the formula (2) like the formula (1). Similarly to the logarithmic frequency spectrum, normalization of the amplitude of the cross-correlation function Cₜ⁽ⁱ⁻¹⁾(τ, n) can be performed.

The feature extractor 103 extracts the set of the cross-correlation functions, Cₜ⁽ⁱ⁾(τ, n) (τεN, nεL) thus calculated, as the local and relative fundamental-frequency pattern feature at the frame t.

According to the second embodiment, the cross-correlations between frames other than the subject frame are also considered. Accordingly, a more stable local and relative fundamental-frequency pattern feature can be obtained than in the case that only the cross-correlations between the subject frame and other frames are considered.

A third embodiment of the present invention is explained with reference to FIGS. 8 to 10. The same or corresponding parts as those in the first embodiment are denoted by like reference numerals, and explanations thereof will be omitted.

FIG. 8 is a block diagram of a functional configuration of the feature extracting apparatus 100 according to the third embodiment. As shown in FIG. 8, the feature extracting apparatus 100 according to the third embodiment is different from that of the first embodiment in that it includes a dimension compressor 105 that compresses dimensions of the cross-correlation function at each time, which is calculated by the cross-correlation function calculator 102 at each time.

The dimension compressor 105 serves as a dimension compressing unit. The dimension compressor 105 compresses the number of dimensions of the cross-correlation function Cₜ(τ, n) (nεL), calculated by the cross-correlation function calculator 102, using discrete cosine transform or principal component analysis at each frame t.

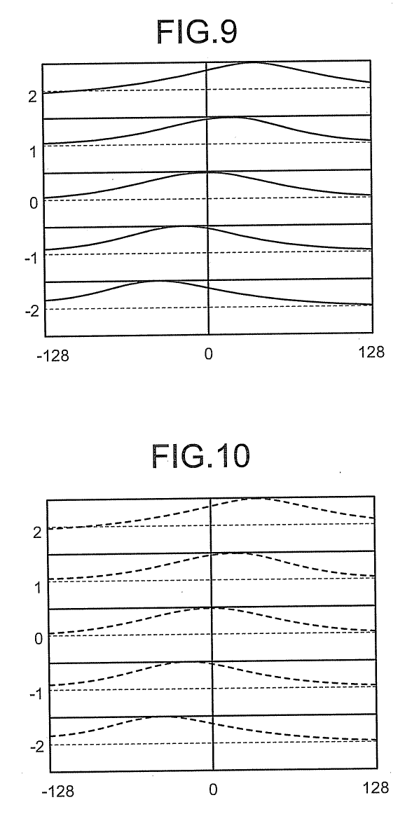

FIG. 9 is a graph of parts taken out from the cross-correlation functions shown in FIG. 4, where a range of the lag is from −30 to 30. The number of dimensions of the cross-correlation function Cₜ(τ, n) (−30=n=30) is 61.

FIG. 10 depicts the cross-correlation functions shown in FIG. 9 approximated by a five-dimensional discrete cosine transform coefficient, respectively. FIG. 10 indicates that almost the same patterns as those of the original cross-correlation functions are obtained even when the dimension compression is performed.

The feature extractor 103 extracts a set of cross-correlation functions obtained by the dimension compression, as the local and relative fundamental-frequency pattern feature.

According to the third embodiment, the local and relative fundamental-frequency pattern feature that is efficiently represented with a smaller number of dimensions can be obtained.

In the feature extracting apparatus 100 according to the third embodiment, the cross-correlation function calculated at each time by the cross-correlation function calculator 102 is dimension-compressed at each time by the dimension compressor 105. However, the present invention is not limited thereto. For example, the dimension compressor 105 can perform the dimension compression at each time after the cross-correlation-function recursive calculator 104 recursively calculates the cross-correlation function at each time from the cross-correlation function calculated at each time by the cross-correlation function calculator 102, as described in the second embodiment.

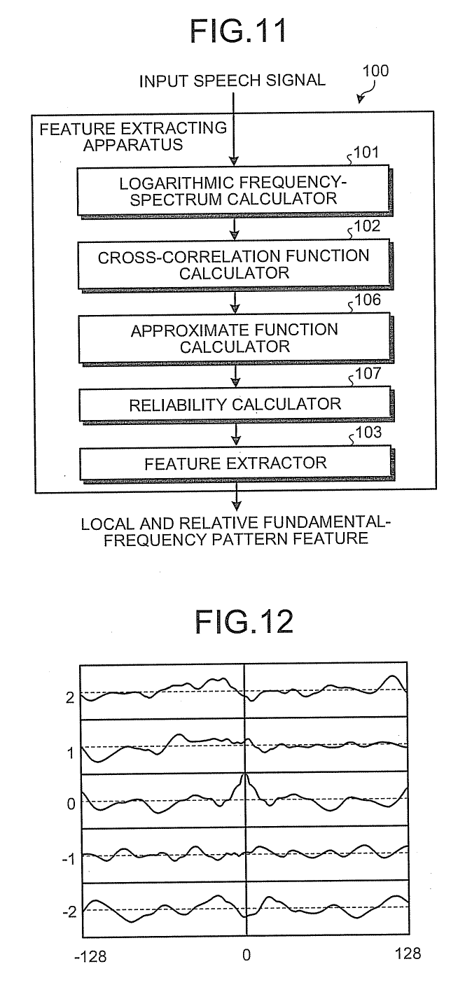

A fourth embodiment of the present invention is explained with reference to FIGS. 11 and 12. The same or corresponding parts as those in the first embodiment are denoted by like reference numerals, and explanations thereof will be omitted.

FIG. 11 is a block diagram of a functional configuration of the feature extracting apparatus 100 according to the fourth embodiment. As shown in FIG. 11, the feature extracting apparatus 100 according to the fourth embodiment is different from that of the first embodiment in that it includes an approximate function calculator 106 that obtains a fundamental-frequency-pattern approximate function at each time from the cross-correlation functions calculated at each time by the cross-correlation function calculator 102, and a reliability calculator 107 that calculates reliability of the fundamental-frequency-pattern approximate function at each time, from the cross-correlation functions calculated at each time by the cross-correlation function calculator 102 and the fundamental-frequency-pattern approximate function calculated at each time by the approximate function calculator 106.

The approximate function calculator 106 serves as an approximate-function calculating unit. The approximate function calculator 106 obtains a local and relative fundamental-frequency-pattern approximate function Fₜ(τ) from a set of the cross-correlation functions, Cₜ(τ, n) (τεN, nεL) calculated by the cross-correlation function calculator 102, at each frame t. When a minimum square error criterion is for example employed, the approximate function Fₜ(τ) can be obtained by minimizing an error Et given by the following formula (3).

$${E}_{t} = {\sum }_{τ ∈ N ( t )} {\sum }_{n ∈ L} {C}_{t} ( τ , n ) {\{ {F}_{t} ( τ ) - n \}}^{2} \qquad ( 3 )$$

The reliability calculator 107 functions as a reliability calculating unit. The reliability calculator 107 obtains reliability of the approximate function Fₜ(τ) from the set of the cross-correlation functions, Cₜ(τ, n) (τεN, nεL), calculated by the cross-correlation function calculator 102 and the local and relative fundamental-frequency-pattern approximate function Fₜ(τ) calculated by the approximate function calculator 106, at each frame t. The reliability is given by a set of values of the cross-correlation functions, Cₜ(τ, Fₜ(τ)) (τεN), on the approximate function Fₜ(τ), or a statistic amount such as the mean, the variance, and the maximum value thereof.

The feature extractor 103 extracts the local and relative fundamental-frequency-pattern approximate function Fₜ(τ) and the reliability thereof thus obtained, as the local and relative fundamental-frequency pattern feature at the frame t.

FIG. 12 is a graph of cross-correlation functions in an unvoiced segment. As shown in FIG. 12, because the unvoiced segment does not include the fundamental frequency, the cross-correlation functions include no clear peak except for the auto-correlation function of the lag 0 (zero). However, according to the formula (3), the approximate function can be obtained also in such cases.

When the fundamental frequency is not included as shown in FIG. 12, the values of the cross-correlation functions are generally small. Accordingly, the values of the cross-correlation functions on the local and relative fundamental-frequency-pattern approximate function are also small. When the fundamental frequency is included and the cross-correlation functions include clear peaks as shown in FIG. 4, the values of the cross-correlation functions on the local and relative fundamental-frequency-pattern approximate function are large. That is, the values of the cross-correlation functions on the local and relative fundamental-frequency-pattern approximate function represents probability of existence of the fundamental frequency.

According to the fourth embodiment, the local and relative fundamental-frequency-pattern approximate function is obtained, so that the local and relative fundamental-frequency pattern feature can be obtained even in an unvoiced segment that normally does not include the fundamental frequency. The reliability of the local and relative fundamental-frequency-pattern approximate function is also obtained, thereby obtaining the local and relative fundamental-frequency pattern feature including the probability of existence of the fundamental frequency.

In the feature extracting apparatus 100 according to the fourth embodiment, the fundamental-frequency-pattern approximate function is obtained by the approximate function calculator 106 at each time, from the cross-correlation functions calculated at each time by the cross-correlation function calculator 102, and the reliability of the fundamental-frequency-pattern approximate function is calculated at each time from the cross-correlation functions calculated at each time from the cross-correlation function calculator 102 and the fundamental-frequency-pattern approximate function calculated at each time by the approximate function calculator 106. However, the present invention is not limited thereto. For example, the approximate function calculator 106 can obtain the fundamental-frequency-pattern approximate function at each time after the cross-correlation-function recursive calculator 104 recursively calculates the cross-correlation functions at each time from the cross-correlation functions calculated at each time by the cross-correlation function calculator 102, as described in the second embodiment.

The present invention is not limited to the embodiments mentioned above. Practically, the constituent elements can be modified without departing from the spirit of the invention to be embodied. Proper combinations of the plural components disclosed in the embodiments can make various inventions. For example, some constituent elements can be eliminated from all the constituent elements described in the embodiments. The constituent elements employed in different embodiments can be properly combined.

The embodiments have described examples of application to the feature extracting apparatus included in the speech recognition apparatus. However, the present invention is not limited thereto. The present invention can be applied to a feature extracting apparatus included in a speech period detecting apparatus, a pitch extracting apparatus, a speaker recognition apparatus, or the like, that needs the fundamental frequency pattern information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A feature extracting apparatus comprising:
a spectrum calculator that calculates a logarithmic frequency spectrum including frequency components obtained from an input speech signal at regular intervals on a logarithmic frequency scale of a frame;
a function calculator that calculates a cross-correlation function between a logarithmic frequency spectrum of a time and a logarithmic frequency spectrum of one or plural times included in a certain temporal width before and after the time, from a sequence of the logarithmic frequency spectra calculated at each time; and
a feature extractor that extracts a set of the cross-correlation functions as a local and relative fundamental-frequency pattern feature at the frame.

2. The apparatus according to claim 1, wherein the logarithmic frequency spectrum calculated by the spectrum calculator is a logarithmic frequency spectrum of residual components that are obtained by eliminating spectrum envelopes.

3. The apparatus according to claim 1, wherein the spectrum calculator normalizes an amplitude of the logarithmic frequency spectrum.

4. The apparatus according to claim 1, further comprising:
a recursive calculator that recursively and repeatedly calculates at each time a cross-correlation function between a cross-correlation function at the time and a cross-correlation function at one or plural times included in a certain temporal width before and after the time, from a sequence of the cross-correlation functions calculated at each time, wherein
the feature extractor extracts a set of the cross-correlation functions recursively and repeatedly calculated by the recursive calculator, as the local and relative fundamental-frequency pattern feature at a frame.

5. The apparatus according to claim 1, further comprising:
a dimension compressor that compresses dimensions of the cross-correlation function at each time, wherein
the feature extractor extracts a set of the cross-correlation functions subjected to the dimension compression by the dimension compressor, as the local and relative fundamental-frequency pattern feature at a frame.

6. The apparatus according to claim 1, further comprising:
an approximate function calculator that obtains an approximate function from the cross-correlation function at each time, wherein
the feature extractor extracts the approximate function obtained by the approximate function calculator as the local and relative fundamental-frequency pattern feature at a frame.

7. The apparatus according to claim 6, further comprising:
a reliability calculator that obtains a sequence and a statistic amount of cross-correlation function values on the approximate function, as reliability of the approximate function, wherein
the feature extractor extracts the reliability obtained by the reliability calculator as the local and relative fundamental-frequency pattern feature at a frame.

8. A computer program product having a computer readable medium including programmed instructions for extracting feature, wherein the instructions, when executed by a computer, cause the computer to perform:
calculating a logarithmic frequency spectrum including frequency components obtained from an input speech signal at regular intervals on a logarithmic frequency scale of a frame;
calculating a cross-correlation function between a logarithmic frequency spectrum of a time and a logarithmic frequency spectrum of one or plural times included in a certain temporal width before and after the time, from a sequence of the logarithmic frequency spectra calculated at each time; and
extracting a set of the cross-correlation functions as a local and relative fundamental-frequency pattern feature at the frame.

9. A feature extracting method comprising:
calculating a logarithmic frequency spectrum including frequency components obtained from an input speech signal at regular intervals on a logarithmic frequency scale of a frame;
calculating a cross-correlation function between a logarithmic frequency spectrum of a time and a logarithmic frequency spectrum of one or plural times included in a certain temporal width before and after the time, from a sequence of the logarithmic frequency spectra calculated at each time; and
extracting a set of the cross-correlation functions as a local and relative fundamental-frequency pattern feature at the frame.
